(19) United States
(12) Patent Application Publication
(10) Pub. No.: US 2018/0016080 A1
(43) Pub. Date: Jan. 18, 2018

(54) Thin Film Diffusion Barrier

(71) Applicants: COMPAGNIE GENERALE DES ETABLISSEMENTS MICHELIN, Clermont-Ferrand (FR); Michelin Recherche Et Technique S.A., Granges-Paccot (CH); The Texas A&M University System, College Station, TX (US)

(72) Inventors: Jaime C. Grunlan, College Station, TX (US); Paul Winston, Greenville, SC (US); Barton E. Stevens, College Station, TX (US)

(21) Appl. No.: 15/538,831

(22) PCT Filed: Dec. 30, 2014
(86) PCT No.: PCT/US14/72856

§ 371 Date: Jun. 22, 2017

(51) Int. Cl. B65D 81/24; B05D 3/06; B05D 3/02; B05D 3/10; B05D 7/00; B05D 7/02

(52) U.S. Cl. CPC B65D 81/24; B05D 7/5883; B05D 7/02; B05D 3/0254; B05D 3/101; B05D 3/06; B05D 3/107

(57) ABSTRACT

A rubber substrate has a material diffusion barrier, and a method produces the same. In an embodiment, a method for producing a material diffusion barrier on a rubber substrate include exposing the rubber substrate to a cationic solution to produce a cationic layer on the rubber substrate. The method also includes exposing the cationic layer to an anionic solution 5 to produce an anionic layer on the cationic layer. The anionic layer comprises graphene oxide. The layer includes the cationic layer and the anionic layer. The layer comprises the material diffusion barrier.

### BACKGROUND OF THE INVENTION

### Field of the Invention

This invention relates to the field of diffusion barriers and more specifically to the field of thin film barriers against diffusion of materials.

### Background of the Invention

Diffusion barriers to gas and vapors are key components in a variety of applications, such as food packaging and flexible electronics. For instance, there is an increased need for improved barrier performance against diffusion of materials for food packaging. Drawbacks to conventional packaging include gas and liquid permeability of the packaging. Such drawbacks may lead to damage to food contained within the packaging. Coatings and liners have been developed for conventional packaging to reduce gas and liquid permeability. Drawbacks to the developed coatings and liners include increased thickness and rigidity of the packaging. Increased thickness may cause an undesired weight increase of the packaging. In addition, such increased rigidity may cause unwanted damage to the packaging.

Consequently, there is a need for improved diffusion barriers. There are also further needs for improved thin film barriers against fluid and solid diffusion.

### BRIEF SUMMARY OF SOME OF THE PREFERRED EMBODIMENTS

These and other needs in the art are addressed in one embodiment by a method for producing a material diffusion barrier on a rubber substrate. The method includes exposing the rubber substrate to a cationic solution to produce a cationic layer on the rubber substrate. The method also includes exposing the cationic layer to an anionic solution to produce an anionic layer on the cationic layer. Additionally, the anionic layer comprises a graphene oxide. In addition, the method includes a layer having the cationic layer and the anionic layer. The layer includes the material diffusion barrier.

These and other needs in the art are addressed by another embodiment of a method for producing a material diffusion barrier on a rubber substrate. The method includes exposing the rubber substrate to an anionic solution to produce an anionic layer on the rubber substrate. Additionally, the anionic layer comprises a graphene oxide. The method also includes exposing the anionic layer to a cationic solution to produce a cationic layer on the anionic layer. In addition, the method includes a layer having the anionic layer and the cationic layer. The layer includes the material diffusion barrier.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a quadlayer on a rubber substrate;

FIG. 2 illustrates an embodiment of a quadlayer, a rubber substrate, and a primer layer:

FIG. 3 illustrates an embodiment of three quadlayers and a rubber substrate;

FIG. 4 illustrates thickness as a function of the number of quad layers;

FIG. 5 illustrates oxygen transmission rate as a function of the number of quadlayers;

FIG. 6 illustrates images of elasticity of coating;

FIG. 7 illustrates an embodiment of a bilayer on a rubber substrate:

FIG. 8 illustrates an embodiment of bilayers of layerable materials and additives;

FIG. 9 illustrates an embodiment of bilayers with alternating layers of layerable materials and additives;

FIG. 10 illustrates an embodiment with bilayers of layerable materials and additives;

FIG. 11 is a chart illustrating the profilometer thickness of branched polyethylenimine/graphene oxide assemblies grown on silicon before and after reduction at 175° C. for 90 minute;

FIG. 12(a) is a scanning electron microscope micrograph of a twenty bilayer branched polyethylenimine/graphene oxide assembly before a 90 minute thermal reduction at 175° C.;

FIG. 12(b) is a scanning electron microscope micrograph of a twenty bilayer branched polyethylenimine/graphene oxide assembly after a 90 minute thermal reduction at 175° C.;

FIG. 12(c) is a transmission electron microscope micrograph of a substrate and a branched polyethylenimine/graphene oxide assembly before thermal reduction showing graphene oxide oriented parallel to the substrate;

FIG. 12(d) illustrates a ten bilayer branched polyethylenimine/graphene oxide assembly applied to a substrate, wherein the thermal reduction of the ten bilayer branched polyethylenimine/graphene oxide assembly results in the originally transparent branched polyethylenimine/graphene oxide assembly (top) becoming opaque, with a graphitic luster (bottom);

FIG. 13 illustrates a C 1s x-ray photoelectron spectrum of graphene oxide before and after a 90 minute reduction at 175° C.; and

FIG. 14 illustrates sheet resistance as a function of exposure time for a twenty bilayer branched polyethylenimine/graphene oxide assembly to various thermal reduction temperatures.

### DETAILED DESCRIPTION OF THE PREFERRED EMBODIMENTS

In an embodiment, a multilayer thin film coating method provides a rubber substrate with a diffusion retardant coating by alternately depositing positive and negative charged layers on the substrate. Each pair of positive and negative layers comprises a layer. In embodiments, the multilayer thin film coating method produces any number of desired layers on substrates such as bilayers, trilayers, quadlayers, pentalayers, hexalayers, heptalayers, octalayers, and increasing layers. Without limitation, a layer or plurality of layers may provide a desired yield. Further, without limitation, a plurality of layers may provide a desired retardant to transmission of material through the rubber substrate. The material may be any diffusible material. Without limitation, the diffusible material may be a solid, a fluid, or any combinations thereof. The fluid may be any diffusible fluid such as a liquid, a gas, or any combinations thereof. In an embodiment, the diffusible fluid is a gas.

The positive and negative layers may have any desired thickness. In embodiments, each layer is between about 0.5 nanometers and about 100 nanometers thick, alternatively between about 1 nanometer and about 100 nanometers thick, and alternatively between about 0.5 nanometers and about 10 nanometers thick. In some embodiments of the multilayer thin film coating method, one or more of the positive layers are neutral rather than positively charged.

The rubber substrate comprises material having viscoelasticity. Any desirable rubber substrate may be coated with the multilayer thin film coating method. Without limitation, examples of suitable rubber substrates include polyisoprene, polychloroprene, butadiene-styrene copolymers, acrylonitrilebutadiene copolymers, ethylenepropylene-diene rubbers, polysulfide rubber, nitrile rubber, silicone, polyurethane, butyl rubber, or any combinations thereof.

The negative charged (anionic) layers comprise layerable materials. The layerable materials include anionic polymers, colloidal particles, or any combinations thereof. Without limitation, examples of suitable anionic polymers include polystyrene sulfonate, polymethacrylic acid, polyacrylic acid, poly(acrylic acid, sodium salt), polyanetholesulfonic acid sodium salt, poly(vinylsulfonic acid, sodium salt), or any combinations thereof. In addition, without limitation, colloidal particles include organic and/or inorganic materials. Further, without limitation, examples of colloidal particles include graphene oxide, clays, colloidal silica, inorganic hydroxides, silicon based polymers, polyoligomeric silsesquioxane, carbon nanotubes, graphene, or any combinations thereof. Without limitation by theory, it is believed that the use of graphene oxide may impart a layer that is conductive. This conductive layer may be used to dissipate static charges from the rubber substrate (e.g., a tire). Graphene oxide may comprise a compound of carbon, oxygen, and hydrogen in variable ratios. The graphene oxide may be formed by any suitable method. In one embodiment, the graphene oxide may be obtained by treating graphite with strong oxidizers. Graphene oxide may be included in embodiment by using a solution of graphene oxide, wherein the graphene oxide may be included in the solution in an amount between about 0.01 wt. % to about 25 wt. %. Any type of clay suitable for use in an anionic solution may be used. Without limitation, examples of suitable clays include sodium montmorillonite, hectorite, saponite, Wyoming bentonite, vermiculite, halloysite, or any combinations thereof. In an embodiment, the clay is sodium montmorillonite. Any inorganic hydroxide that may provide retardancy to gas or vapor transmission may be used. In an embodiment, the inorganic hydroxide includes aluminum hydroxide, magnesium hydroxide, or any combinations thereof.

The positive charge (cationic) layers comprise cationic materials. In some embodiments, one or more cationic layers are neutral. The cationic materials comprise polymers, colloidal particles, nanoparticles, or any combinations thereof. The polymers include cationic polymers, polymers with hydrogen bonding, or any combinations thereof. Without limitation, examples of suitable cationic polymers include branched polyethylenimine, linear polyethylenimine, cationic polyacrylamide, cationic poly diallyldimethylammonium chloride, poly(allyl amine), poly(allyl amine) hydrochloride, poly(vinyl amine), poly(acrylamide-co-diallyldimethylammonium chloride), or any combinations thereof. Without limitation, examples of suitable polymers with hydrogen bonding include polyethylene oxide, polyglycidol, polypropylene oxide, poly(vinyl methyl ether), polyvinyl alcohol, polyvinylpyrolidone, polyallylamine, branched polyethylenimine, linear polyethylenimine, poly(acrylic acid), poly(methacrylic acid), polyionic liquids, copolymers thereof, or any combinations thereof. In embodiments, the polymers with hydrogen bonding are neutral polymers. In addition, without limitation, colloidal particles include organic and/or inorganic materials. Further, without limitation, examples of colloidal particles include clays, layered double hydroxides, inorganic hydroxides, silicon based polymers, polyoligomeric silsesquioxane, carbon nanotubes, graphene, or any combinations thereof. Without limitation, examples of suitable layered double hydroxides include hydrotalcite, magnesium LDH, aluminum LDH, or any combinations thereof.

In embodiments, the positive (or neutral) and negative layers are deposited on the rubber substrate by any suitable method. Embodiments include depositing the positive (or neutral) and negative layers on the rubber substrate by any suitable liquid deposition method. Without limitation, examples of suitable methods include bath coating, spray coating, slot coating, spin coating, curtain coating, gravure coating, reverse roll coating, knife over roll (i.e., gap) coating, metering (Meyer) rod coating, air knife coating, or any combinations thereof. Bath coating includes immersion or dip. In an embodiment, the positive (or neutral) and negative layers are deposited by bath. In other embodiments, the positive and negative layers are deposited by spray.

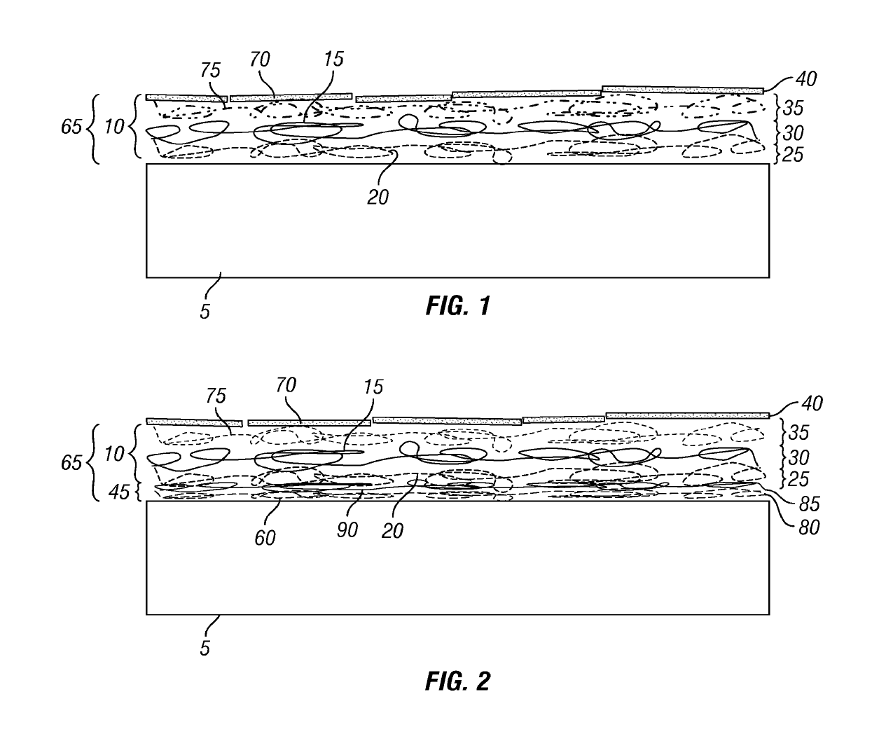

In embodiments, the multilayer thin film coating method provides two pairs of positive and negative layers, which two pairs comprise a quadlayer. Embodiments include the multilayer thin film coating method producing a plurality of quad layers on a rubber substrate. FIG. 1 illustrates an embodiment of rubber substrate 5 with coating 65 of quadlayer 10. In an embodiment to produce the coated rubber substrate 5 shown in FIG. 1, the multilayer thin film coating method includes exposing rubber substrate 5 to cationic molecules in a cationic mixture to produce first cationic layer 25 on rubber substrate 5. The cationic mixture contains first layer cationic materials 20. In an embodiment, first layer cationic materials 20 are positively charged or neutral. In embodiments, first layer cationic materials 20 are neutral. In some embodiments, first layer cationic materials 20 are polymers with hydrogen bonding having a neutral charge. Embodiments include first layer cationic materials 20 comprising polyethylene oxide. Without limitation, first layer cationic materials 20 comprising neutral materials (i.e., polyethylene oxide) may provide a desired yield. In such an embodiment, rubber substrate 5 is negatively charged or neutral. Embodiments include rubber substrate 5 having a negative charge. Without limitation, a negatively charged rubber substrate 5 provides a desired adhesion. The cationic mixture includes an aqueous solution of first layer cationic materials 20. The aqueous solution may be prepared by any suitable method. In embodiments, the aqueous solution includes first layer cationic materials 20 and water. In other embodiments, first layer cationic materials 20 may be dissolved in a mixed solvent, in which one of the solvents is water and the other solvent is miscible with water (e.g., water, methanol, and the like). The solution may also contain colloidal particles in combination with polymers or alone, if positively charged. Any suitable water may be used. In embodiments, the water is deionized water. In some embodiments, the aqueous solution may include from about 0.05 wt. % first layer cationic materials 20 to about 1.50 wt. % first layer cationic materials 20, alternatively from about 0.01 wt. % first layer cationic materials 20 to about 2.00 wt. % first layer cationic materials 20, and further alternatively from about 0.001 wt. % first layer cationic materials 20 to about 20.0 wt. % first layer cationic materials 20. In embodiments, rubber substrate 5 may be exposed to the cationic mixture for any suitable period of time to produce first cationic layer 25. In embodiments, rubber substrate 5 is exposed to the cationic mixture from about 1 second to about 20 minutes, alternatively from about 1 second to about 200 seconds, and alternatively from about 10 seconds to about 200 seconds, and further alternatively from about instantaneous to about 1.200 seconds. Without limitation, the exposure time of rubber substrate 5 to the cationic mixture and the concentration of first layer cationic materials 20 in the cationic mixture affect the thickness of first cationic layer 25. For instance, the higher the concentration of first layer cationic materials 20 and the longer the exposure time, the thicker the first cationic layer 25 produced by the multilayer thin film coating method.

In embodiments, after formation of first cationic layer 25, multilayer thin film coating method includes removing rubber substrate 5 with the produced first cationic layer 25 from the cationic mixture and then exposing rubber substrate 5 with first cationic layer 25 to anionic molecules in an anionic mixture to produce first anionic layer 30 on first cationic layer 25. The anionic mixture contains first layer layerable materials 15. Without limitation, the positive or neutral first cationic layer 25 attracts the anionic molecules to form the cationic (or neutral)-anionic pair of first cationic layer 25 and first anionic layer 30. The anionic mixture includes an aqueous solution of first layer layerable materials 15. In an embodiment, first layer layerable materials 15 comprise polyacrylic acid. The aqueous solution may be prepared by any suitable method. In embodiments, the aqueous solution includes first layer layerable materials 15 and water. First layer layerable materials 15 may also be dissolved in a mixed solvent, in which one of the solvents is water and the other solvent is miscible with water (e.g., ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % first layer layerable materials 15 to about 1.50 wt. % first layer layerable materials 15, alternatively from about 0.01 wt. % first layer layerable materials 15 to about 2.00 wt. % first layer layerable materials 15, and further alternatively from about 0.001 wt. % first layer layerable materials 15 to about 20.0 wt. % first layer layerable materials 15. In embodiments, rubber substrate 5 with first cationic layer 25 may be exposed to the anionic mixture for any suitable period of time to produce first anionic layer 30. In embodiments, rubber substrate 5 with first cationic layer 25 is exposed to the anionic mixture from about 1 second to about 20 minutes, alternatively from about 1 second to about 200 seconds, and alternatively from about 10 seconds to about 200 seconds, and further alternatively from about instantaneous to about 1,200 seconds. Without limitation, the exposure time of rubber substrate 5 with first cationic layer 25 to the anionic mixture and the concentration of first layer layerable materials 15 in the anionic mixture affect the thickness of the first anionic layer 30. For instance, the higher the concentration of first layer layerable materials 15 and the longer the exposure time, the thicker the first anionic layer 30 produced by the multilayer thin film coating method.

In embodiments as further shown in FIG. 1, after formation of first anionic layer 30, the multilayer thin film coating method includes removing rubber substrate 5 with the produced first cationic layer 25 and first anionic layer 30 from the anionic mixture and then exposing rubber substrate 5 with first cationic layer 25 and first anionic layer 30 to cationic molecules in a cationic mixture to produce second cationic layer 35 on first anionic layer 30. The cationic mixture contains second layer cationic materials 75. In an embodiment, second layer cationic materials 75 are positively charged or neutral. In embodiments, second layer cationic materials 75 are positive. In some embodiments, second layer cationic materials 75 comprise branched polyethylenimine. The cationic mixture includes an aqueous solution of second layer cationic materials 75. The aqueous solution may be prepared by any suitable method. In embodiments, the aqueous solution includes second layer cationic materials 75 and water. In other embodiments, second layer cationic materials 75 may be dissolved in a mixed solvent, in which one of the solvents is water and the other solvent is miscible with water (e.g., water, methanol, and the like). The solution may also contain colloidal particles in combination with polymers or alone, if positively charged. Any suitable water may be used. In embodiments, the water is deionized water. In some embodiments, the aqueous solution may include from about 0.05 wt. % second layer cationic materials 75 to about 1.50 wt. % second layer cationic materials 75, alternatively from about 0.01 wt. % second layer cationic materials 75 to about 2.00 wt. % second layer cationic materials 75, and further alternatively from about 0.001 wt. % second layer cationic materials 75 to about 20.0 wt. % second layer cationic materials 75. In embodiments, rubber substrate 5 may be exposed to the cationic mixture for any suitable period of time to produce second cationic layer 35. In embodiments, rubber substrate 5 is exposed to the cationic mixture from about 1 second to about 20 minutes, alternatively from about 1 second to about 200 seconds, and alternatively from about 10 seconds to about 200 seconds, and further alternatively from about instantaneous to about 1,200 seconds.

In embodiments, after formation of the second cationic layer 35, multilayer thin film coating method includes removing rubber substrate 5 with the produced first cationic layer 25, first anionic layer 30, and second cationic layer 35 from the cationic mixture and then exposing rubber substrate 5 with first cationic layer 25, first anionic layer 30, and second cationic layer 35 to anionic molecules in an anionic mixture to produce second anionic layer 40 on second cationic layer 35. The anionic mixture contains second layer layerable materials 70. Without limitation, the positive or neutral second cationic layer 35 attracts the anionic molecules to form the cationic (or neutral)-anionic pair of second cationic layer 35 and second anionic layer 40. The anionic mixture includes an aqueous solution of second layer layerable materials 70. In an embodiment, second layer layerable materials 70 comprise graphene oxide. The aqueous solution may be prepared by any suitable method. In embodiments, the aqueous solution includes second layer layerable materials 70 and water. Second layer layerable materials 70 may also be dissolved in a mixed solvent, in which one of the solvents is water and the other solvent is miscible with water (e.g., ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % second layer layerable materials 70 to about 1.50 wt. % second layer layerable materials 70, alternatively from about 0.01 wt. % second layer layerable materials 70 to about 2.00 wt. % second layer layerable materials 70, and further alternatively from about 0.001 wt. % second layer layerable materials 70 to about 20.0 wt. % second layer layerable materials 70. In embodiments, rubber substrate 5 with first cationic layer 25, first anionic layer 30, and second cationic layer 35 may be exposed to the anionic mixture for any suitable period of time to produce second anionic layer 40. In embodiments, rubber substrate 5 with first cationic layer 25, first anionic layer 30, and second cationic layer 35 is exposed to the anionic mixture from about 1 second to about 20 minutes, alternatively from about 1 second to about 200 seconds, and alternatively from about 10 seconds to about 200 seconds, and further alternatively from about instantaneous to about 1,200 seconds. Quadlayer 10 is therefore produced on rubber substrate 5. In embodiments as shown in FIG. 1 in which rubber substrate 5 has one quadlayer 10, coating 65 comprises quadlayer 10. In embodiments, quadlayer 10 comprises first cationic layer 25, first anionic layer 30, second cationic layer 35, and second anionic layer 40.

In an embodiment as shown in FIG. 2, coating 65 also comprises primer layer 45. Primer layer 45 is disposed between rubber substrate 5 and first cationic layer 25 of quadlayer 10. Primer layer 45 may have any number of layers. The layer of primer layer 45 proximate to rubber substrate 5 has a charge with an attraction to rubber substrate 5, and the layer of primer layer 45 proximate to first cationic layer 25 has a charge with an attraction to first cationic layer 25. In embodiments as shown in FIG. 2, primer layer 45 is a bilayer having a first primer layer 80 and a second primer layer 85. In such embodiments, first primer layer 80 is a cationic layer (or alternatively neutral) comprising first primer layer materials 60, and second primer layer 85 is an anionic layer comprising second primer layer materials 90. First primer layer materials 60 comprise cationic materials. In an embodiment, first primer layer materials 60 comprise polyethylenimine. Second primer layer materials 90 comprise layerable materials. In an embodiment, second primer layer materials 90 comprise polyacrylic acid. In other embodiments (not shown), primer layer 45 has more than one bilayer.

In further embodiments as shown in FIG. 2, the multilayer thin film coating method includes exposing rubber substrate 5 to cationic molecules in a cationic mixture to produce first primer layer 80 on rubber substrate 5. The cationic mixture contains first primer layer materials 60. In an embodiment, first primer layer materials 60 are positively charged or neutral. In embodiments, the cationic mixture includes an aqueous solution of first primer layer materials 60. The aqueous solution may be prepared by any suitable method. In embodiments, the aqueous solution includes first primer layer materials 60 and water. In other embodiments, first primer layer materials 60 may be dissolved in a mixed solvent, in which one of the solvents is water and the other solvent is miscible with water (e.g., water, methanol, and the like). The solution may also contain colloidal particles in combination with polymers or alone, if positively charged. Any suitable water may be used. In embodiments, the water is deionized water. In some embodiments, the aqueous solution may include from about 0.05 wt. % first primer layer materials 60 to about 1.50 wt. % first primer layer materials 60, alternatively from about 0.01 wt. % first primer layer materials 60 to about 2.00 wt. % first primer layer materials 60, and further alternatively from about 0.001 wt. % first primer layer materials 60 to about 20.0 wt. % first primer layer materials 60. In embodiments, rubber substrate 5 may be exposed to the cationic mixture for any suitable period of time to produce first primer layer 80. In embodiments, rubber substrate 5 is exposed to the cationic mixture from about 1 second to about 20 minutes, alternatively from about 1 second to about 200 seconds, and alternatively from about 10 seconds to about 200 seconds, and further alternatively from about instantaneous to about 1,200 seconds.

In embodiments as shown in FIG. 2, after formation of first primer layer 80, multilayer thin film coating method includes removing rubber substrate 5 with the produced first primer layer 80 from the cationic mixture and then exposing rubber substrate 5 with first primer layer 80 to anionic molecules in an anionic mixture to produce second primer layer 85 on first primer layer 80. The anionic mixture contains second primer layer materials 90. The anionic mixture includes an aqueous solution of second primer layer materials 90. The aqueous solution may be prepared by any suitable method. In embodiments, the aqueous solution includes second primer layer materials 90 and water. Second primer layer materials 90 may also be dissolved in a mixed solvent, in which one of the solvents is water and the other solvent is miscible with water (e.g., ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % second primer layer materials 90 to about 1.50 wt. % second primer layer materials 90, alternatively from about 0.01 wt. % second primer layer materials 90 to about 2.00 wt. % second primer layer materials 90, and further alternatively from about 0.001 wt. % second primer layer materials 90 to about 20.0 wt. % second primer layer materials 90. In embodiments, the rubber substrate 5 with first primer layer 80 may be exposed to the anionic mixture for any suitable period of time to produce second primer layer 85. In embodiments, rubber substrate 5 with first primer layer 80 is exposed to the anionic mixture from about 1 second to about 20 minutes, alternatively from about 1 second to about 200 seconds, and alternatively from about 10 seconds to about 200 seconds, and further alternatively from about instantaneous to about 1,200 seconds. Rubber substrate 5 with primer layer 45 is then removed from the anionic mixture and then the multilayer thin film coating method proceeds to produce quadlayer 10.

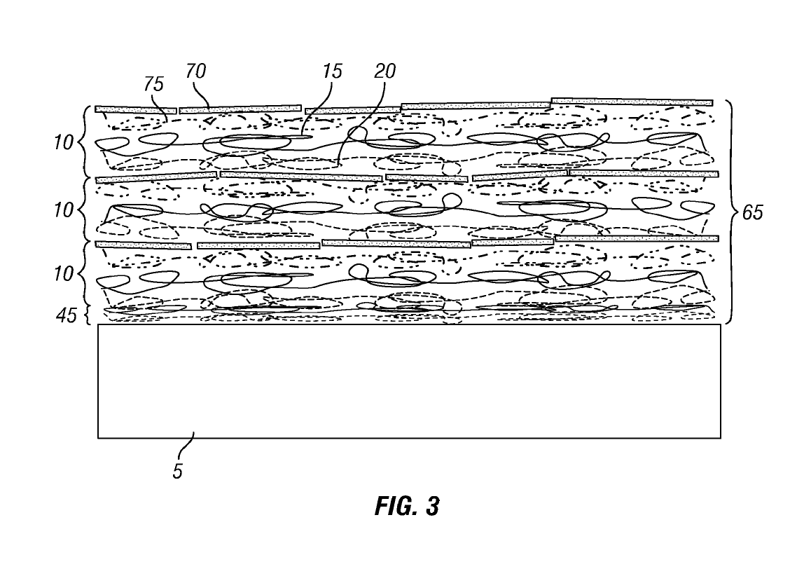

In embodiments as shown in FIG. 3, the exposure steps are repeated with substrate 5 having quadlayer 10 continuously exposed to the cationic mixture and then the anionic mixture to produce a coating 65 having multiple quadlayers 10. The repeated exposure to the cationic mixture and then the anionic mixture may continue until the desired number of quadlayers 10 is produced. Coating 65 may have any sufficient number of quad layers 10 to provide rubber substrate 5 with a desired retardant to gas or vapor transmission. In an embodiment, coating 65 has between about 1 quadlayer 10 and about 40 quadlayers 10, alternatively between about 1 quadlayer 10 and about 1,000 quadlayers 10.

In an embodiment, the multilayer thin film coating method provides a coated rubber substrate 5 (e.g., comprising coating 65) with a yield between about 0.1% and about 100%, alternatively between about 1% and about 10%. In addition, embodiments include the multilayer thin film coating method providing a coated rubber substrate 5 having a gas transmission rate between about 0.02 cc/(m²*day*atm) and about 0.03 cc/(m²*day*atm), alternatively about 0.03 cc/(m²*day*atm) and about 100 cc/(m²*day*atm), alternatively between about 0.3 cc/(m²*day*atm) and about 100 cc/(m²*day*atm), and further alternatively between about 3 cc/(m²*day*atm) and about 30 cc/(m²*day*atm).

It is to be understood that the multilayer thin film coating method is not limited to exposure to a cationic mixture followed by an anionic mixture. In embodiments in which rubber substrate 5 is positively charged, the multilayer thin film coating method includes exposing rubber substrate 5 to the anionic mixture followed by exposure to the cationic mixture. In such embodiment (not illustrated), first anionic layer 30 is deposited on rubber substrate 5 with first cationic layer 25 deposited on first anionic layer 30, and second anionic layer 40 is deposited on first cationic layer 25 followed by second cationic layer 35 deposited on second anionic layer 40 to produce quadlayer 10 with the steps repeated until coating 65 has the desired thickness. In embodiments in which rubber substrate 5 has a neutral charge, the multilayer thin film coating method may include beginning with exposure to the cationic mixture followed by exposure to the anionic mixture or may include beginning with exposure to the anionic mixture followed by exposure to the cationic mixture.

In embodiments (not shown), quadlayers 10 may have one or more than one cationic layer (i.e., first cationic layer 25, second cationic layer 35, cationic layers in primer layer 45) comprised of more than one type of cationic materials. In an embodiment (not shown), quadlayers 10 may have one or more than one anionic layer (i.e., first anionic layer 30, second anionic layer 40, anionic layers in primer layer 45) comprised of more than one type of anionic material. In some embodiments, one or more cationic layers are comprised of the same materials, and/or one or more of the anionic layers are comprised of the same anionic materials. It is to be understood that coating 65 is not limited to one layerable material but may include more than one layerable material and/or more than one cationic material.

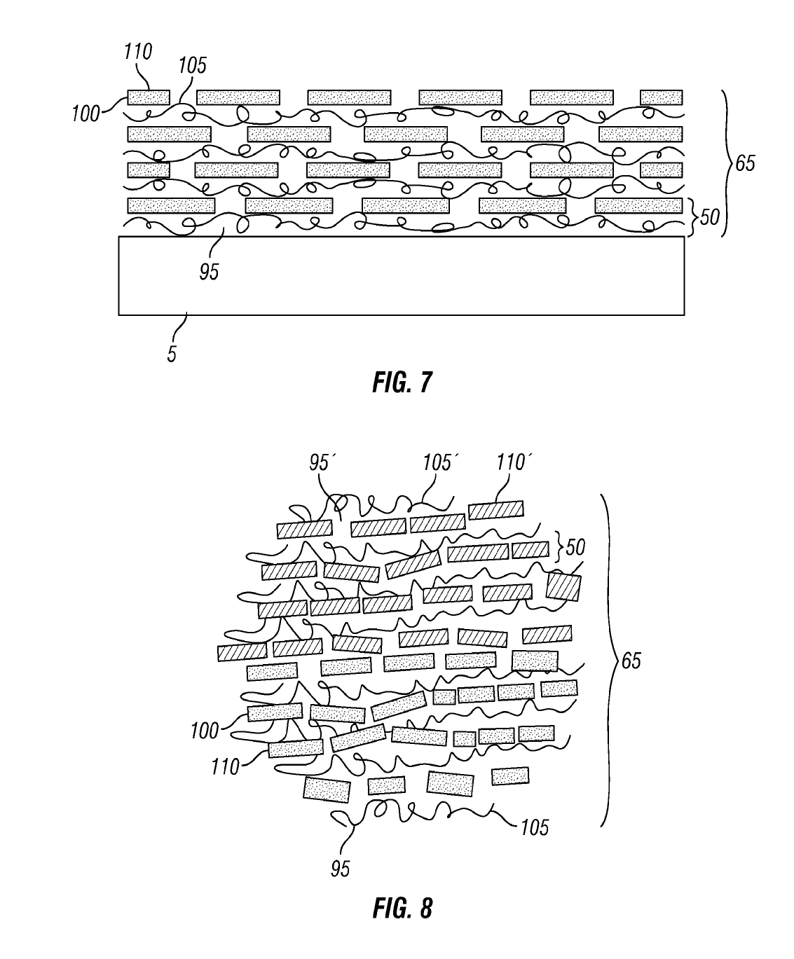

FIG. 7 illustrates an embodiment of rubber substrate 5 with coating 65 of multiple bilayers 50. It is to be understood that the multilayer thin film coating method produces the coated rubber substrate 5 by the embodiments set forth above and shown in FIGS. 1-3. As shown in FIG. 7, each bilayer 50 has cationic layer 95 and anionic layer 100. In embodiments as shown, cationic layer 95 has cationic materials 105, and anionic layer 100 has layerable materials 110. In the embodiment as shown, the multilayer thin film coating method produces coating 65 by exposure to a cationic mixture followed by an anionic mixture according to the embodiments above. In an embodiment, bilayer 50 has cationic materials 105 comprising branched polyethylenimine, and layerable materials 110 comprising graphene oxide.

It is to be understood that the multilayer thin film coating method for preparing rubber substrate 5 with coating 65 having bilayers 50 is not limited to exposure to a cationic mixture followed by an anionic mixture. In embodiments in which rubber substrate 5 is positively charged, the multilayer thin film coating method includes exposing rubber substrate 5 to the anionic mixture followed by exposure to the cationic mixture. In such embodiment (not illustrated), anionic layer 100 is deposited on rubber substrate 5 with cationic layer 95 deposited on anionic layer 100 to produce bilayer 50 with the steps repeated until coating 65 has the desired thickness. In embodiments in which rubber substrate 5 has a neutral charge, the multilayer thin film coating method may include beginning with exposure to the cationic mixture followed by exposure to the anionic mixture or may include beginning with exposure to the anionic mixture followed by exposure to the cationic mixture.

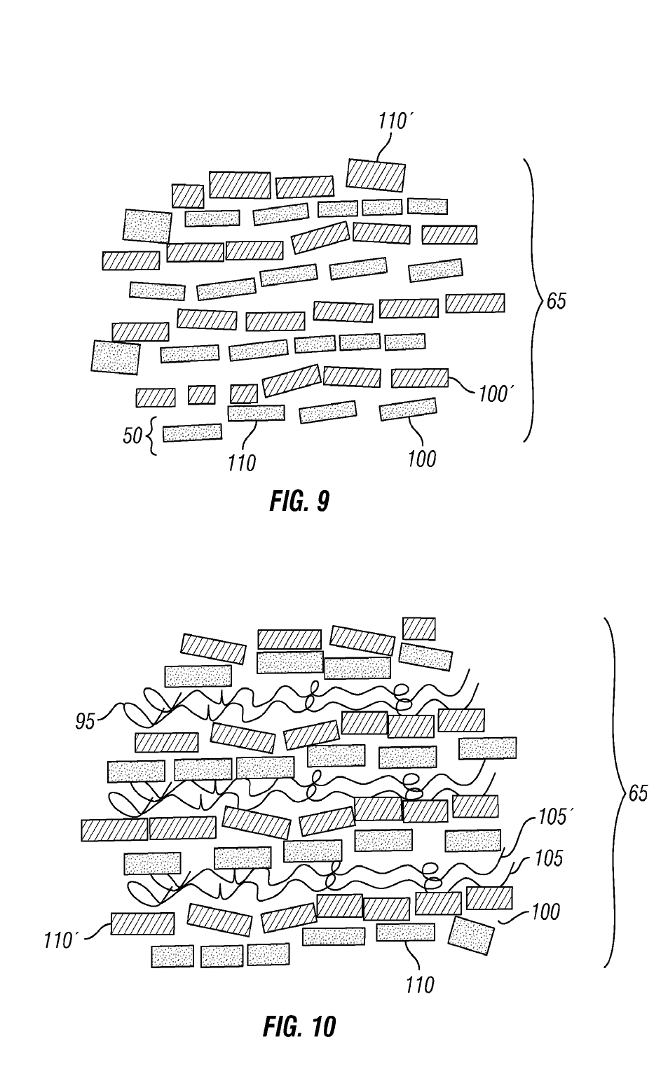

It is to be further understood that coating 65 is not limited to one layerable material 110 and/or one cationic material 105 but may include more than one layerable material 110 and/or more than one cationic material 105. The different layerable materials 110 may be disposed on the same anionic layer 100, alternating anionic layers 100, or in layers of bilayers 50 (i.e., or in layers of trilayers or increasing layers). The different cationic materials 105 may be dispersed on the same cationic layer 95, alternating cationic layers 95, or in layers of bilayers 50 (i.e., or in layers of trilayers or increasing layers). For instance, in embodiments as illustrated in FIGS. 8-10, coating 65 includes two types of layerable materials 110, 110′ (i.e., graphene oxide is a layerable material 110 and aluminum hydroxide is layerable material 110′). It is to be understood that rubber substrate 5 is not shown for illustrative purposes only in FIGS. 8-10. FIG. 8 illustrates an embodiment in which layerable materials 110, 110′ are in different layers of bilayers 50. For instance, as shown in FIG. 8, layerable materials 110′ are deposited in the top bilayers 50 after layerable materials 110 are deposited on rubber substrate 5 (not illustrated). FIG. 9 illustrates an embodiment in which coating 65 has layerable materials 110, 110′ in alternating bilayers 50. It is to be understood that cationic materials 105 are not shown for illustrative purposes only in FIG. 9. FIG. 10 illustrates an embodiment in which there are two types of bilayers 50, comprised of particles (layerable materials 110, 110′) and cationic materials 105, 105′ (e.g., polymers).

FIGS. 7-10 do not show coating 65 having primer layer 45. It is to be understood that embodiments of coating 65 having bilayers 50 also may have primer layer 45. Embodiments (not illustrated) of coating 65 having trilayers, pentalayers, and the like may also have primer layer 45.

It is to be understood that the multilayer thin film coating method produces coatings 65 of trilayers, pentalayers, and increasing layers by the embodiments disclosed above for bilayers 50 and quadlayers 10. It is to be understood that coating 65 is not limited to only a plurality of bilayers 50, trilayers, quadlayers 10, pentalayers, hexalayers, heptalayers, octalayers, or increasing layers. In embodiments, coating 65 may have any combination of such layers.

In some embodiments in which coating 65 comprises trilayers, the trilayers comprise a first cationic layer comprising polyethylenimine, a second cationic layer comprising polyethylene oxide or polyglycidol, and an anionic layer comprising graphene oxide. In such an embodiment, the second cationic layer is disposed between the first cationic layer and the anionic layer. In another embodiment in which coating 65 comprises trilayers, the trilayers comprise a first cationic layer comprising polyethylenimine, an anionic layer comprising graphene oxide, and a second cationic layer comprising polyethylene oxide or polyglycidol. In such an embodiment, the anionic layer is disposed between the first cationic layer and the second cationic layer. In some embodiments in which coating 65 comprises trilayers, the trilayers comprise a cationic layer comprising polyethylene oxide or polyglycidol, a first anionic layer comprising polyacrylic acid or polymethacrylic acid, and a second anionic layer comprising graphene oxide. In such an embodiment, the first anionic layer is disposed between the cationic layer and the second anionic layer.

In embodiments where the anionic layer comprises graphene oxide, the graphene oxide may be reduced by any suitable method. In embodiments, suitable methods to reduce the graphene oxide may include thermal reduction, chemical reduction, an infrared radiation light source, microwaves, or any combination thereof. In an embodiment, the graphene oxide layer(s) may be applied and reduced in a “roll-to-roll” fashion, wherein a graphene oxide layer is applied and then reduced by thermal reduction using an oven or other heat source or by chemical reduction using a reducing chemical application. In some embodiments, the reduction may happen in a batch process after the coating 65 has been applied, if the batch process is carried out in an embodiment in which the coating 65 is able to withstand the chosen reduction process. In embodiments using thermal reduction, the graphene oxide layer or coating 65, as well as any rubber substrate 5 (e.g., a tire) may be heated using any suitable heat source. The heat may be applied at a temperature of about 50° C. to about 200° C. for a time interval between about 1 minute and about 10 hours. In a specific example embodiment, a temperature of 175° C. may be used for 90 minutes. In embodiments comprising a chemical reduction, chemical reducing agents may be used to reduce the anionic layer(s) comprising graphene oxide. Any chemical reducing agent suitable for the multilayer thin film coating method may be used. In embodiments, the chemical reducing agents include citric acid, hydrazine hydrate, urea, or any combination thereof. Reduction of the anionic layer(s) comprising graphene oxide may increase the electrical conductivity of the coating 65. Without limitation, coating 65 may comprise an electrical conductivity between about 500 S/m to about 2500 S/m, alternatively about 1500 S/m to about 2000 S/m, and further alternatively about 1700 S/m to about 1800 S/m. Without limitation by theory, reduction of the anionic layers comprising graphene oxide layer may be important for reducing diffusion of oxygen, water, and the like across the thin film diffusion barrier; decreasing the thickness of the anionic layer comprising graphene oxide: reducing the swellability of the thin film diffusion barrier; increasing the electrical conductivity of the thin film diffusion barrier.

In some embodiments, the multilayer thin film coating method includes rinsing rubber substrate 5 between each (or alternatively more than one) exposure step (i.e., step of exposing to cationic mixture or step of exposing to anionic mixture). For instance, after rubber substrate 5 is removed from exposure to the cationic mixture, rubber substrate 5 with first cationic layer 25 is rinsed and then exposed to an anionic mixture. In some embodiments, quadlayer 10 is rinsed before exposure to the same or another cationic and/or anionic mixture. In an embodiment, coating 65 is rinsed. The rinsing is accomplished by any rinsing liquid suitable for removing all or a portion of ionic liquid from rubber substrate 5 and any layer. In embodiments, the rinsing liquid includes deionized water, methanol, or any combinations thereof. In an embodiment, the rinsing liquid is deionized water. A layer may be rinsed for any suitable period of time to remove all or a portion of the ionic liquid. In an embodiment, a layer is rinsed for a period of time from about 5 seconds to about 5 minutes. In some embodiments, a layer is rinsed after a portion of the exposure steps.

In embodiments, the multilayer thin film coating method includes drying rubber substrate 5 between each (or alternatively more than one) exposure step (i.e., step of exposing to cationic mixture or step of exposing to anionic mixture). For instance, after rubber substrate 5 is removed from exposure to the cationic mixture, rubber substrate 5 with first cationic layer 25 is dried and then exposed to an anionic mixture. In some embodiments, quadlayer 10 is dried before exposure to the same or another cationic and/or anionic mixture. In an embodiment, coating 65 is dried. The drying is accomplished by applying a drying gas to rubber substrate 5. The drying gas may include any gas suitable for removing all or a portion of liquid from rubber substrate 5. In embodiments, the drying gas includes air, nitrogen, or any combinations thereof. In an embodiment, the drying gas is air. In some embodiments, the air is filtered air. The drying may be accomplished for any suitable period of time to remove all or a portion of the liquid from a layer (i.e., quadlayer 10) and/or coating 65. In an embodiment, the drying is for a period of time from about 5 seconds to about 500 seconds. In an embodiment in which the multilayer thin film coating method includes rinsing after an exposure step, the layer is dried after rinsing and before exposure to the next exposure step. In alternative embodiments, drying includes applying a heat source to the layer (i.e., quadlayer 10) and/or coating 65. For instance, in an embodiment, rubber substrate 5 is disposed in an oven for a time sufficient to remove all or a portion of the liquid from a layer. In some embodiments, drying is not performed until all layers have been deposited, as a final step before use.

In some embodiments (not illustrated), additives may be added to rubber substrate 5 in coating 65. In embodiments, the additives may be mixed in anionic mixtures with layerable materials. In other embodiments, the additives are disposed in anionic mixtures that do not include layerable materials. In some embodiments, coating 65 has a layer or layers of additives. In embodiments, the additives are anionic materials. The additives may be used for any desirable purpose. For instance, additives may be used for protection of rubber substrate 5 against ultraviolet light or for abrasion resistance. For ultraviolet light protection, any negatively charged material suitable for protection against ultraviolet light and for use in coating 65 may be used. In an embodiment, examples of suitable additives for ultraviolet protection include titanium dioxide, or any combinations thereof. In embodiments, the additive is titanium dioxide. For abrasion resistance, any additive suitable for abrasion resistance and for use in coating 65 may be used. In embodiments, examples of suitable additives for abrasion resistance include crosslinkers. Any crosslinker suitable for use with a rubber may be used. In an embodiment, crosslinkers comprise a di-aldehyde. Examples of crosslinkers include glutaraldehyde, bromoalkanes, or any combinations thereof. The crosslinkers may be used to crosslink the anionic layers and/or cationic layers (i.e., first cationic layer 25 and first anionic layer 30). In an embodiment, rubber substrate 5 with coating 65 is exposed to additives in an anionic mixture.

In some embodiments, the pH of the anionic and/or cationic solution is adjusted. Without being limited by theory, reducing the pH of the cationic solution reduces growth of coating 65. Further, without being limited by theory, the coating 65 growth may be reduced because the cationic solution may have a high charge density at lowered pH values, which may cause the polymer backbone to repel itself into a flattened state. In some embodiments, the pH is increased to increase the coating 65 growth and produce a thicker coating 65. Without being limited by theory, a lower charge density in the cationic mixture provides an increased coiled polymer. The pH may be adjusted by any suitable means such as by adding an acid or base. In an embodiment, the pH of an anionic solution is between about 0 and about 14, alternatively between about 1 and about 7. Embodiments include the pH of a cationic solution that is between about 0 and about 14, alternatively between about 3 and about 12.

The exposure steps in the anionic and cationic mixtures may occur at any suitable temperature. In an embodiment, the exposure steps occur at ambient temperatures. In some embodiments, coating 65 is optically transparent.

In an embodiment, rubber substrate 5 may comprise a portion or all of the rubber portions of a tire. In such an embodiment, coating 65 may provide a barrier that limits gas (i.e., oxygen), vapor, and/or chemicals to pass through the tire. Rubber substrate 5 with coating 65 may be used for any suitable portions of a tire such as, without limitation, the carcass, the innerliner, and the like. In an embodiment, the carcass of a tire comprises rubber substrate 5 with coating 65.

To further illustrate various illustrative embodiments of the present invention, the following examples are provided.

### Example 1

Materials.

Natural sodium montmorillonite (MMT)(CLOISITE*® NA+, which is a registered trademark of Southern Clay Products. Inc.) clay was used as received. Individual MMT platelets had a negative surface charge in deionized water, reported density of 2.86 g/cm³, thickness of 1 nm, and a nominal aspect ratio (l/d)≧200. Branched polyethylenimine (PEI) (M_{w}=25,000 g/mol and Mₙ=10,000 g/mol), polyethylene oxide (PEO) (M_{w}=4,000,000 g/mol) and polyacrylic acid (PAA) (35 wt. % in water, M_{w}=100,000 g/mol) were purchased from Sigma-Aldrich (Milwaukee, Wis.) and used as received. 500 μm thick, single-side-polished, silicon wafers were purchased from University Wafer (South Boston, Mass.) and used as reflective substrates for film growth characterization via ellipsometry.

Film Preparation.

All film deposition mixtures were prepared using 18.2MΩ deionized water, from a DIRECT-Q® 5 Ultrapure Water System, and rolled for one day (24 h) to achieve homogeneity. DIRECT-Q® is a registered trademark of Millipore Corporation. Prior to deposition, the pH of 0.1 wt. % aqueous solutions of PEI were altered to 10 or 3 using 1.0 M HCl, the pH of 0.1 wt. % aqueous solutions of PEO were altered to 3 using 1.0 M HCl, the pH of 0.2 wt. % aqueous solutions of PAA were altered to 3 using 1.0 M HCl, and the pH of 2.0 wt. % aqueous suspensions of MMT were altered to 3 using 1.0 M HCl. Silicon wafers were piranha treated for 30 minutes prior to rinsing with water, acetone, water again and finally dried with filtered air prior to deposition. Rubber substrates were rinsed with deionized water, immersed in a 40 wt. % propanol in water bath at 40° C. for 5 minutes, rinsed with RT 40 wt. % propanol in water, rinsed with deionized water, dried with filtered air, and plasma cleaned for 5 minutes on each side. Each appropriately treated substrate was then dipped into the PEI solution at pH 10 for 5 minutes, rinsed with deionized water, and dried with filtered air. The same procedure was followed when the substrate was next dipped into the PAA solution. Once this initial bilayer was deposited, the above procedure was repeated when the substrate was dipped into the PEO solution, then the PAA solution, then the PEI solution at pH 3, and finally the MMT suspension, using 5 second dip times for polymer solutions and using one minute dip times for the MMT suspension, until the desired number of quadlayers of PEO/PAA/PEI/MMT were achieved. All films were prepared using a home-built robotic dipping system.

Film Characterization.

Film thickness was measured every one to five quadlayers (on silicon wafers) using an ALPHA-SE® ellipsometer. ALPHA-SE® is a registered trademark of J.A. Woollam Co., Inc. OTR testing was performed by Mocon, Inc. in accordance with ASTM D-3985, using an Oxtran 2/21 ML instrument at 0% RH.

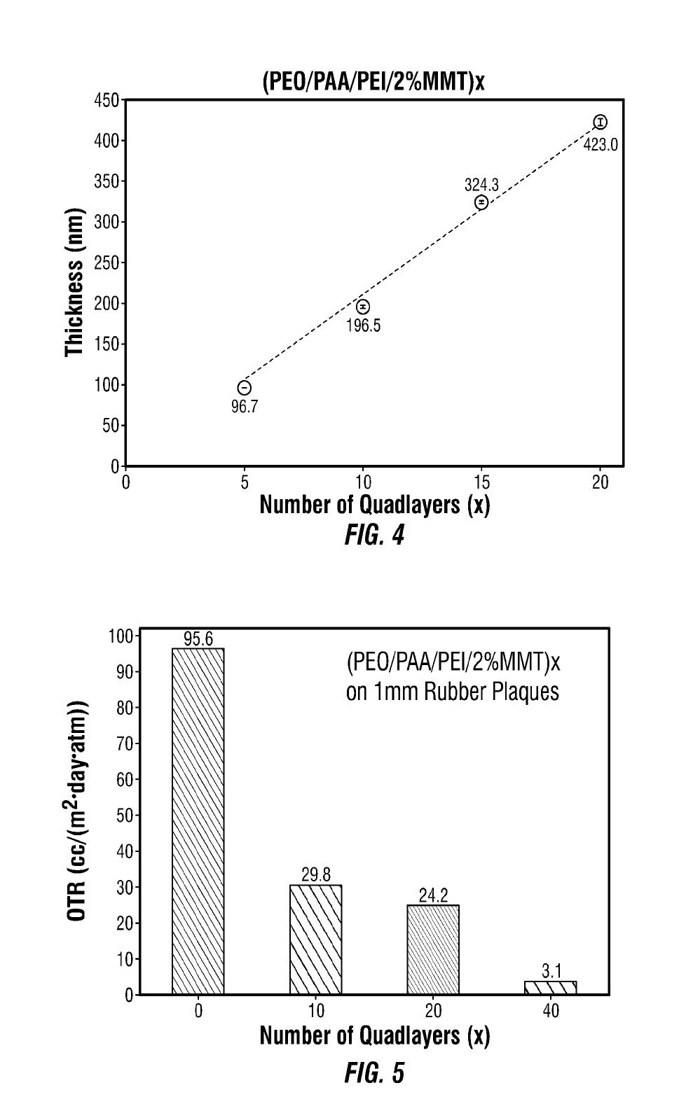

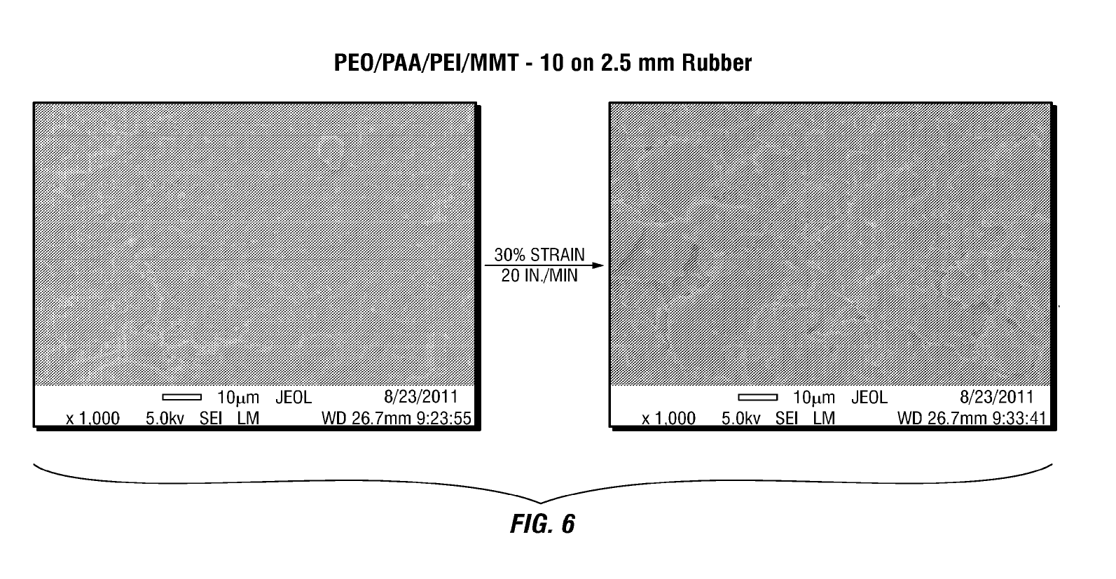

From the results, FIG. 4 illustrates thickness as a function of the number of quadlayers PEO/PAA/PEI/MMT when deposited on a silicon wafer and measured via ellipsometry. FIG. 5 illustrates results of oxygen transmission rate (OTR) as a function of the number of quadlayers of PEO/PAA/PEI/MMT when deposited on a 1 mm thick rubber plaque. FIG. 6 illustrates the elasticity of a coating of which the image on the left is 10 QLs on rubber, and the image on the right is the same coating stretched at 20 inches per minute to 30% strain. This right image showed no sign of mud-cracking and revealed the conformality of the coating to the stretched rubber surface.

### Example 2

Film Preparation.

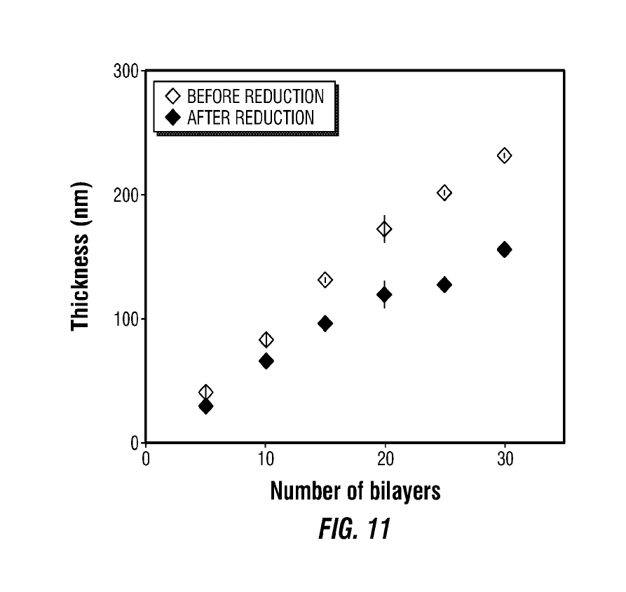

Thin film growth was achieved with an aqueous polyethylenimine (PEI) solution (0.1 wt. % at pH 10) and aqueous graphene oxide (GO) suspension (0.1 wt. % at pH 3.3) through an alternating deposition sequence on 175 μm poly(ethylene terephthalate) (“PET”) film. This layer-by-layer process resulted in anion-cation bilayers on the substrate through the formation of electrostatic interactions. Profilometry was used to monitor the thickness of these films, both as-prepared and after thermally reducing the films at 175° C. for 90 minutes as shown in FIG. 11.

Film Characterization.

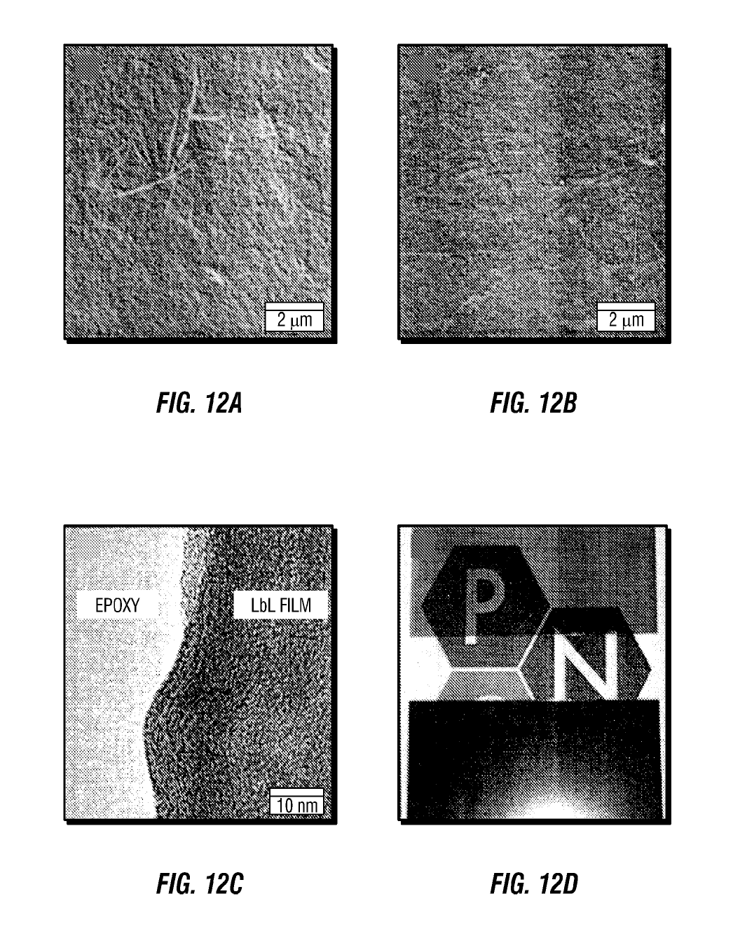

At 20 bilayers, the film thickness was approximately 173 nm, as measured on silicon, although thermal reduction reduces this value to 120 nm (i.e., 70% of original thickness). Additionally, the coverage of GO was uniform across the assembly, and the observed wrinkling of GO platelets diminished upon reduction as shown in FIGS. 12(a), (b). The TEM images indicated that GO platelets were aligned parallel to the direction of the substrate and packed closely together as shown in FIG. 12(c). Although the density of graphene oxide appeared to be high, the film was optically transparent until it was thermally reduced, at which point the film obtains a metallic luster similar to that of graphite as shown in FIG. 12(d).

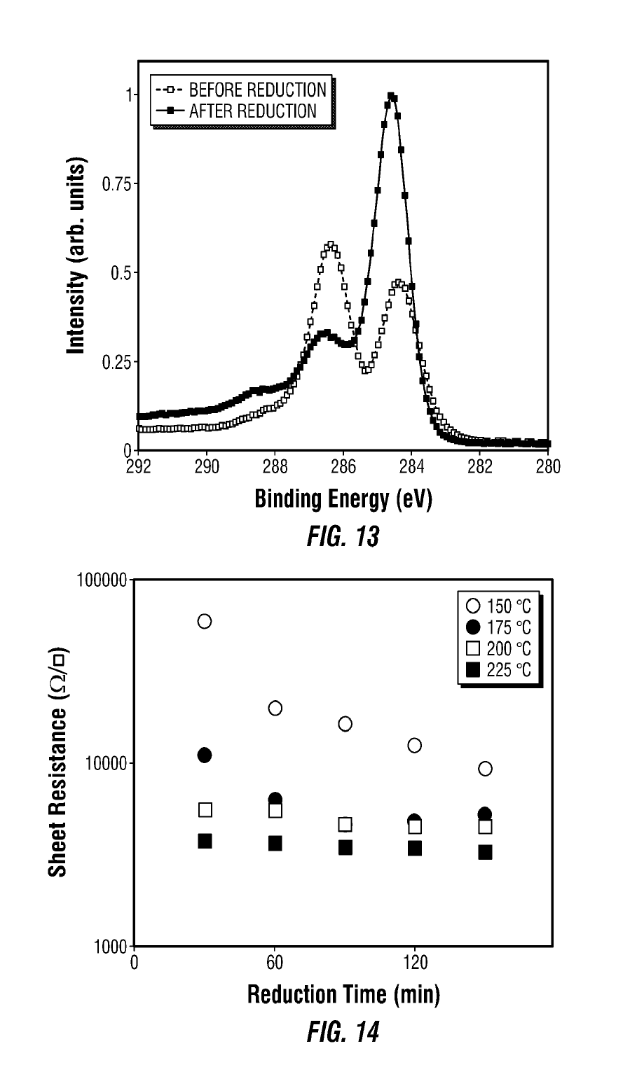

Thermal reduction of GO was monitored by electrical conductivity and X-ray photoelectron spectroscopy (XPS) measurements. In the most reduced state, the PEI/GO films exhibited a decrease in electrical sheet resistance by more than 4 orders of magnitude. Four-point probe resistivity measurements indicated that electrical sheet resistance decreased from >1×10⁷ Ω/□ to 4760Ω/□ following a 90 minute reduction at 175° C. (in an ambient atmosphere), corresponding to a conductivity of 1750 S/m. Increased electrical conductivity was the result of partial restoration of sp² carbon bonds in the reduced GO. XPS revealed a decrease in C 1s peak intensity at 286.5 eV, relative to 284.5 eV, indicative of fewer C—O bonds and higher sp² carbon content characteristic of graphite as shown in FIG. 13.

It is important to note that the reduction conditions used for these PEI/GO assemblies on 175 μm thick, commercial-grade PET were mild, and no loss of film or substrate integrity was observed by SEM. Because these assemblies displayed a continuum of electrical resistivities between their pre-reduced and maximally reduced states, it was apparent that the degree of reduction may be tailored, along with the associated properties as shown in FIG. 14.

Table 1 summarizes the oxygen barrier properties of these assemblies, which were measured with oxygen transmission rate (OTR) testing of coated PET samples, in both 0% (dry) and 100% (humid) relative humidity conditions. Prior to thermal reduction, the GO/PEI multilayer thin films displayed excellent barrier properties to oxygen under dry conditions; indeed, with as few as 10 bilayers, dry OTR decreased from 8.6 to 0.0078 cc m⁻² day⁻¹ atm⁻¹. Depositing 20 PEI/GO bilayers caused the OTR to drop below the detection limit of commercial instrumentation (<0.005 cc m⁻² day⁻¹ atm⁻¹). When a 90 minute thermal reduction at 175° C. was applied to these 10 and 20 bilayer assemblies, both exhibited OTR values below detection. Reduction of the GO decreased 10 bilayer film permeability from 15 to <7.0×10⁻²² cm²/Pa/s, a value comparable to the lowest reported dry oxygen film permeability measured for an LbL film.

TABLE 1
Oxygen Transmission Rate and Permeability Data for GO/PEI Assemblies
on PET, Before and After a 90 Minute Thermal Reduction at 175° C.

| | | Hu- | OTR | Total | LbL film |
|---|---|---|---|---|---|
| | Thick- | mid- | (cc m⁻² | Permeability | permeability |
| | ness | ity | day⁻¹ | (×10⁻¹⁵ cm²/ | (×10⁻¹⁸ cm²/ |
| System | (nm) | (%) | atm⁻¹ | (pa/s)) | (Pa/s)) |
| Bare PET | — | — | 8.6 | 1.7 | — |
| 10 BL unreduced | 84 | 0 | 0.0078 | 0.0016 | 0.0015 |
| 10 BL reduced | 66 | 0 | <0.0047 | <0.00095 | <0.00070 |
| 10 BL unreduced | 84 | 100 | 5.8 | 1.2 | 3.3 |
| 10 BL reduced | 66 | 100 | 0.09 | 0.20 | 0.17 |
| 20 BL unreduced | 173 | 0 | <0.0047 | <0.00095 | <0.0018 |
| 20 BL reduced | 120 | 0 | <0.0047 | <0.00095 | <0.0013 |
| 20 BL unreduced | 173 | 100 | 5.4 | 1.1 | 5.8 |
| 20 BL reduced | 120 | 100 | 0.022 | 0.0044 | 0.0060 |

Under humid conditions, pre-reduced and reduced assemblies show a wide disparity. With 20 bilayers deposited, the OTR of GO/PEI exhibited little improvement over bare PET, decreasing by less than a factor of 2. When thermally reduced, the humid OTR of the resulting reduced GO/PEI assemblies decreased to 0.98 and 0.022 cc m⁻² day⁻¹ atm⁻¹ for 10 and 20 bilayer films, respectively. Although the OTR barrier observed in dry conditions was not fully realized in humid conditions, these assemblies reduced oxygen transmission substantially better than bare PET. GO-based assemblies have displayed a propensity for dry oxygen barrier applications, but humid oxygen barrier has been difficult to achieve due to the hydrophilic nature of the assemblies that leads to swelling and increased permeability. Compaction of PEI/GO assemblies upon reduction effectively increased the nanoplatelet concentration, and hydrophilic GO was transformed into hydrophobic reduced GO, which likely inhibits film swelling.

Although the present invention and its advantages have been described in detail, it should be understood that various changes, substitutions and alterations may be made herein without departing from the spirit and scope of the invention as defined by the appended claims.

What is claimed is:

1. A method for producing a material diffusion barrier on a rubber substrate, comprising:
(A) exposing the rubber substrate to a cationic solution to produce a cationic layer on the rubber substrate;
(B) exposing the cationic layer to an anionic solution to produce an anionic layer on the cationic layer, wherein the anionic layer comprises graphene oxide, wherein a layer comprises the cationic layer and the anionic layer, and wherein the layer comprises the material diffusion barrier.

2. The method of claim 1, further comprising reducing the anionic layer comprising graphene oxide to produce a reduced graphene oxide layer.

3. The method of claim 2, wherein reducing the anionic layer comprising graphene oxide comprises thermal reduction, chemical reduction, an infrared radiation light source, microwaves, or a combinations thereof.

4. The method of claim 1, wherein the cationic solution comprises cationic materials, and wherein the cationic materials comprise a polymer, a colloidal particle, a nanoparticle, or any combinations thereof.

5. The method of claim 4, wherein the polymer comprises a polymer with hydrogen bonding, wherein the polymer with hydrogen bonding comprises polyethylene oxide, polyglycidol, polypropylene oxide, poly(vinyl methyl ether), polyvinyl alcohol, polyvinylpyrrolidone, polyallylamine, branched polyethylenimine, linear polyethylenimine, poly(acrylic acid), poly(methacrylic acid), polyionic liquids, copolymers thereof, or any combinations thereof.

6. The method of claim 1, further comprising:
(C) exposing the anionic layer to a second cationic solution to produce a second cationic layer on the anionic layer, and
(D) exposing the second cationic layer to a second anionic solution to produce a second anionic layer on the second cationic layer, wherein the layer comprises a quadlayer comprising the cationic layer, the anionic layer, the second cationic layer, and the second anionic layer.

7. The method of claim 6, wherein the second anionic solution comprises layerable materials, and wherein the layerable materials comprise an anionic polymer, a colloidal particle, or any combinations thereof.

8. The method of claim 7, wherein the anionic polymer comprises a polystyrene sulfonate, a polymethacrylic acid, a polyacrylic acid, a poly(acrylic acid, sodium salt), a polyanetholesulfonic acid sodium salt, poly(vinylsulfonic acid, sodium salt), or any combinations thereof.

9. The method of claim 1, wherein the rubber substrate further comprises a primer layer disposed between the rubber substrate and the cationic layer.

10. The method of claim 1, further comprising repeating steps (A) and (B) to produce a plurality of layers, wherein the material diffusion barrier comprises the plurality of layers.

11. A method for producing a material diffusion barrier on a rubber substrate, comprising:
(A) exposing the rubber substrate to an anionic solution to produce an anionic layer on the rubber substrate, wherein the anionic layer comprises graphene oxide;
(B) exposing the anionic layer to a cationic solution to produce a cationic layer on the anionic layer, wherein a layer comprises the anionic layer and the cationic layer, and wherein the layer comprises the material diffusion barrier.

12. The method of claim 11, further comprising reducing the anionic layer comprising graphene oxide to produce a reduced graphene oxide layer.

13. The method of claim 12, wherein reducing the anionic layer comprising grapheme oxide comprises thermal reduction, chemical reduction, an infrared radiation light source, microwaves, or a combinations thereof.

14. The method of claim 11, wherein the cationic solution comprises cationic materials, and wherein the cationic materials comprise a polymer, a colloidal particle, a nanoparticle, or any combinations thereof.

15. The method of claim 14, wherein the polymer comprises a polymer with hydrogen bonding, wherein the polymer comprises polyethylene oxide, polyglycidol, polypropylene oxide, poly(vinyl methyl ether), polyvinyl alcohol, polyvinylpyrrolidone, polyallylamine, branched polyethylenimine, linear polyethylenimine, poly(acrylic acid), poly(methacrylic acid), polyionic liquids, copolymers thereof, or any combinations thereof.

16. The method of claim 11, further comprising:
(C) exposing the cationic layer to a second anionic solution to produce a second anionic layer on the cationic layer; and
(D) exposing the second anionic layer to a second cationic solution to produce a second cationic layer on the second anionic layer, wherein the layer comprises a quadlayer comprising the anionic layer, the cationic layer, the second anionic layer, and the second cationic layer.

17. The method of claim 16, wherein the second anionic solution comprises layerable materials, and wherein the layerable materials comprise an anionic polymer, a colloidal particle, or any combinations thereof.

18. The method of claim 17, wherein the anionic polymer comprises a polystyrene sulfonate, a polymethacrylic acid, a polyacrylic acid, a poly(acrylic acid, sodium salt), a polyanetholesulfonic acid sodium salt, poly(vinylsulfonic acid, sodium salt), or any combinations thereof.

19. The method of claim 11, wherein the rubber substrate further comprises a primer layer disposed between the rubber substrate and the anionic layer.

20. The method of claim 11, further comprising repeating steps (A) and (B) to produce a plurality of layers, wherein the material diffusion barrier comprises the plurality of layers.
